(19) United States
(12) Patent Application Publication
(10) Pub. No.: US 2019/0037825 A1
(43) Pub. Date: Feb. 7, 2019

(54) Fishing Line Monitoring System

(71) Applicant: Wynand Du Plooy, Sinoville (ZA)

(72) Inventor: Wynand Du Plooy, Sinoville (ZA)

(21) Appl. No.: 16/056,159

(22) Filed: Aug. 6, 2018

Related U.S. Application Data
(60) Provisional application No. 62/541,758, filed on Aug. 6, 2017.

(51) Int. Cl. A01K 97/12; A01K 89/00; A01K 87/00; A01K 91/20

(52) U.S. Cl. CPC A01K 97/125; A01K 91/20; A01K 87/007; A01K 89/00

(57) ABSTRACT

A fishing system that includes a sensing unit mountable about a fishing rod for detecting fish activity about a fishing line, the sensing unit includes a rotatable portion that allows the sensing unit, when mounted between two fishing pole eyelets, to provide sensory information to a transceiver unit when a portion of a wheel passes about the sensing unit, for alerting of the loss of fishing line from the fishing pole.

### CROSS-REFERENCE TO RELATED APPLICATION

This application is related to and claims benefit to U.S. Provisional Patent Application Ser. No. 62/541,758, filed Aug. 6, 2017, entitled Fishing Line Monitoring System, the entirety of which is incorporated herein by reference.

### FIELD OF THE INVENTION

The present invention relates to a fishing system, and more particularly to a fishing system for alerting of fishing line let out from a fishing reel when a fish is hooked.

### BACKGROUND OF THE INVENTION

It is very common for yachts to cruise the seas with one or more fishing lines from a fishing pole in the ocean water, which may result in the eventual hooking of a fish on the fishing pole. In many instances, a ship's crew will maintain the fishing lines until the fishing pole receives a bite. Once a bite is on the line, the crew must slow its ship speed to prevent the loss of the fish and to reduce the amount of line being let out from the fishing pole due to the hooked fish causing drag against the reel. Failing to slow the ship and immediately reeling in the fish typically results in longer struggles catching the fish. The crew will in many cases alert its passengers/guests on board the yacht who will then reel in the catch.

One problem exists because neither the passengers, nor the crew typically sit and watch the fishing poles when the line is in the water because it can take quite a long time to hook a fish. And because it is uncommon for passengers or crew to constantly monitor the fishing rod and reel, the fish will eventually break the fishing line or escape the hook before any person aboard the yacht becomes aware of the hooked fish. This commonly results in the eventual loss of a hooked fish before it is reeled in.

There is no prior art capable of securing with a fishing pole along the shaft of the fishing pole and wirelessly alerting one or more persons that line from the fishing pole is being let out.

There is a need in the art for a fishing line bite detection system, which is capable of alerting any of the Captain, ship's crew, and passengers/guests aboard the yacht.

### SUMMARY OF THE INVENTION

The present invention advantageously provides a fishing system for alerting of fishing line let out from a fishing reel when a fish is hooked. The system includes a sensing device that couples with a rod of a fishing pole and a fishing line about the fishing pole.

According to an embodiment of the present invention, a principal object is to provide a fishing line detection system capable of detecting and wirelessly alerting persons, including for example the captain of the ship, crew members of the ship, and/or passengers/guests of the ship.

According to an embodiment of the present invention, another object is to provide a sensing unit that is mounted about a fishing rod, the sensing unit includes a rotatable portion that allows the sensing unit, when mounted between two fishing pole, to provide sensory information to a transceiver unit when a portion of a wheel passes about the sensing unit, for alerting of the loss of fishing line from the fishing pole. In this regard, the captain can slow the ship to prevent additional loss of fishing line, as the further loss of fishing line reduces the likelihood that the fish will ultimately be caught/brought on board the ship.

According to an embodiment of the present invention, another object is to provide a transceiver that includes a motion detection device integrated into the portable transceiver with a capability of alerting wirelessly a portable receiver of a motion detection. In this manner, the motion detector can be placed at entrances, or other locations of the ship, for alerting nearby a captain, crew, or passengers of the detection of persons entering the ship, or other desired uses. For example, the motion detector can be utilized while camping to alert users of motion within the user's tent, cooler, etc., such that the user can hike or be away from the camp ground without fear of theft or tampering with the camp grounds. Further, the transceiver with the integrated motion detector can be utilized in vehicles while the user shops in a store, such that the user will bring the receiver with them and the transceiver will alert if motion is detected inside the vehicle, thereby alerting of broken windows.

Yet another object of the present invention is to provide a system for alerting a user of fishing line let out from the fishing pole due to a hooked fish.

Other objects will become evident as the present invention is described in detail below.

### BRIEF DESCRIPTION OF THE DRAWINGS

Embodiments of the present application are described herein in which similar elements are given similar reference characters, and a more complete understanding of the present invention, and the attendant advantages and features thereof, will be more readily understood by reference to the following detailed description when considered in conjunction with the accompanying drawings wherein:

FIG. 1 is a perspective view of two fishing systems with two sensing device, each sensing device coupled with the shaft of a fishing pole;

FIG. 2 is a perspective view of the sensing device of FIG. 1 in accordance with the principles of the present embodiment;

FIG. 3 is a perspective view of a transmitting unit electrically connected with a sensing unit mounted about a fishing pole;

FIG. 4 is a perspective view side view the sensing device of FIG. 2 in accordance with the principles of the present embodiment; and

FIG. 5 is a top perspective view of a receiving unit capable of receiving sensory information from a transmitting unit.

### DETAILED DESCRIPTION OF THE INVENTION

The present invention advantageously provides a fishing system for alerting of fishing line let out from a fishing reel typically when a fish is hooked. The present invention contemplates various types of device coupling with the fishing system for alerting of the one or more portable fish detection receiving device.

Accordingly, the system has been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

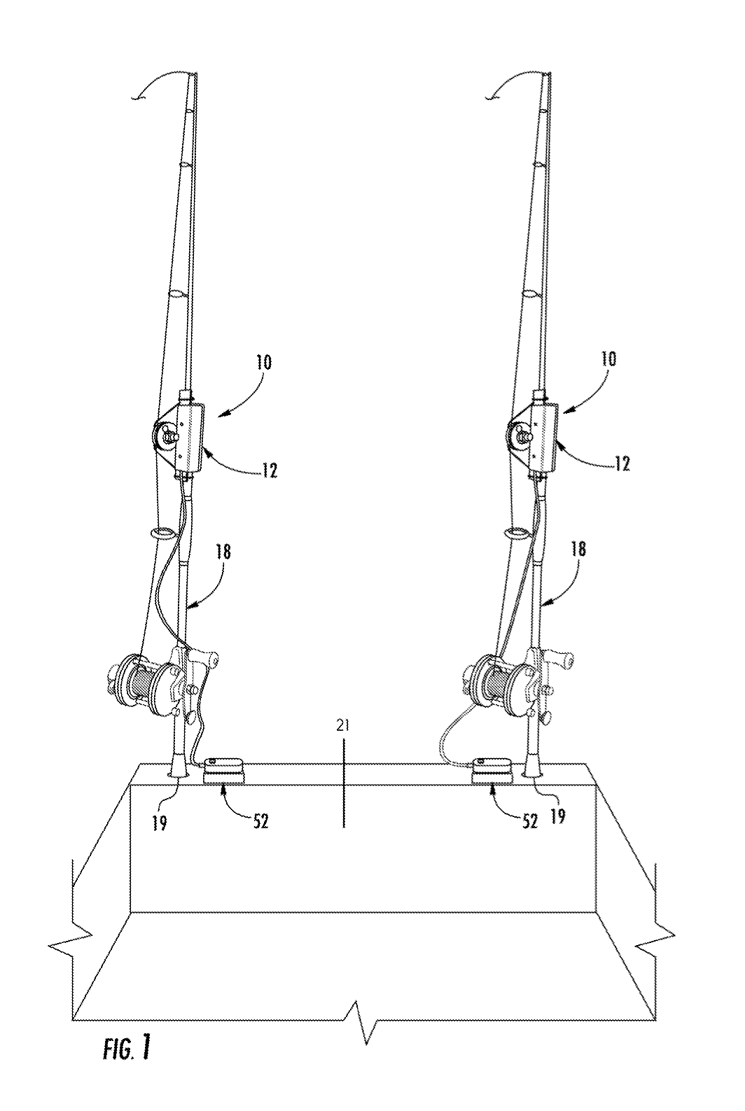

Referring now to the drawings figures in which like reference designators refer to like elements. FIG. 1 shows an exemplary fishing system for alerting of fishing line let out from a fishing reel, most typically when a fish is hooked on the fishing line, in accordance with the principles of the present invention and designated generally as fishing system 10. In FIG. 1, two identical fishing systems are shown side-by-side and coupled with two fishing poles 18, the fishing poles 18 secured in fishing pole holders 19 in the rear of a boat 21.

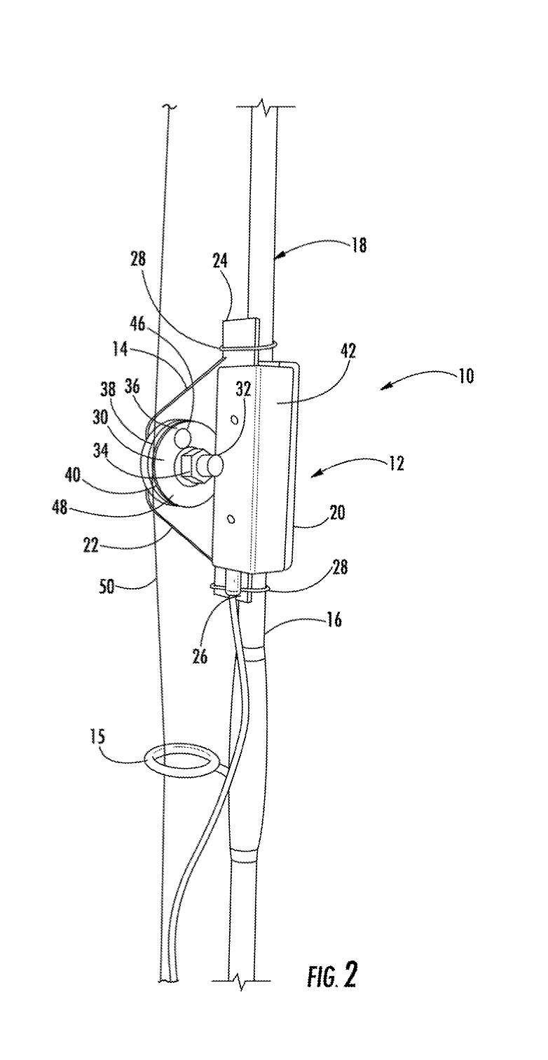

Referring now to FIG. 2, fishing system 10 includes a sensing device 12. The sensing device 12 includes an L-shaped bracket 14 for securing against a length 16 of a fishing pole 18, the fishing pole 18 has multiple eyelets 15 along the length 16, the eyelets 15 guide fishing line 50 from a distal end of the fishing pole 18. The L-shaped bracket includes a fishing pole securement portion 20 and an outward extending portion 22. The fishing pole securement portion 20 and the outward extending portion 22 are formed in a perpendicular relation to each other. In one non-limiting embodiment, the L-shaped bracket 14 is secured between two eyelets 15. The fishing pole securement portion 20 includes an upper distal portion 24 and a lower distal portion 26.

In one non-limiting embodiment, the upper distal portion 24 and the lower distal portion 26 are configured for mounting about the length 16 via securement members 28. Securement members may be any suitable members capable of securing the sensing device against the length 16. For example, the securement members may include without limitation zip ties, twist ties, tape, hook and loop material, or other semi-permanent and/or releasable securement members. Semi-permanent securement members includes those members that would typically be removed via a tool (e.g., scissors or screw drivers).

Wheel 30 is rotatably mounted about the outward extending portion 22 of the L-shaped bracket 14. The wheel 30 is mounted with the outward extending portion 22 via a threaded rod 32 and a reciprocating nut 34. The wheel 30 includes a first beveled edge 36 and a second beveled edge 38. The beveled edges 36, 38 are constructed to form an outer central groove 40. The outer central groove 40 may optionally include a material capable of gripping a fishing line 50. In operation, the passing of the fishing line 50 against the outer central groove 40 causes the wheel 30 to rotate about the invisible axis created by the threaded rod 32. A magnetic member 46 is disposed about an outer surface 48 of the wheel 30.

In one non-limiting embodiment, the reciprocating nut 34 provides adjustable drag for increasing the drag exerted on the wheel in rotation, the reciprocating nut 34 providing increased drag when rotated in a first direction and decreased drag when rotated in the direction opposite the first direction.

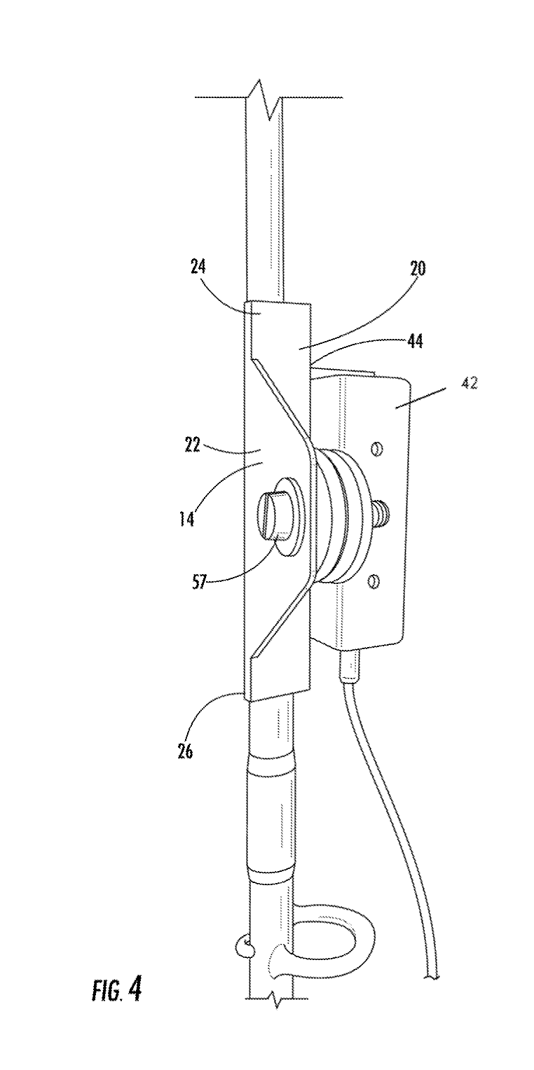

Still referring to FIG. 2, the sensing device 12 further includes a sensing member 42. In one non-limiting embodiment, the sensing member 42 is a reed switch (i.e., a normally closed switch that opens upon removal of a magnet from a defined proximity). The sensing member 42 is mounted against an outward facing surface (see FIGS. 2 and 4) of the fishing pole securement portion 20. In another non-limiting embodiment, the sensing member 42 includes a non-magnetized internal accelerometer to determine circular rotations of the wheel 30 for alerting of fishing line 50 being let out from the fishing pole/fishing reel.

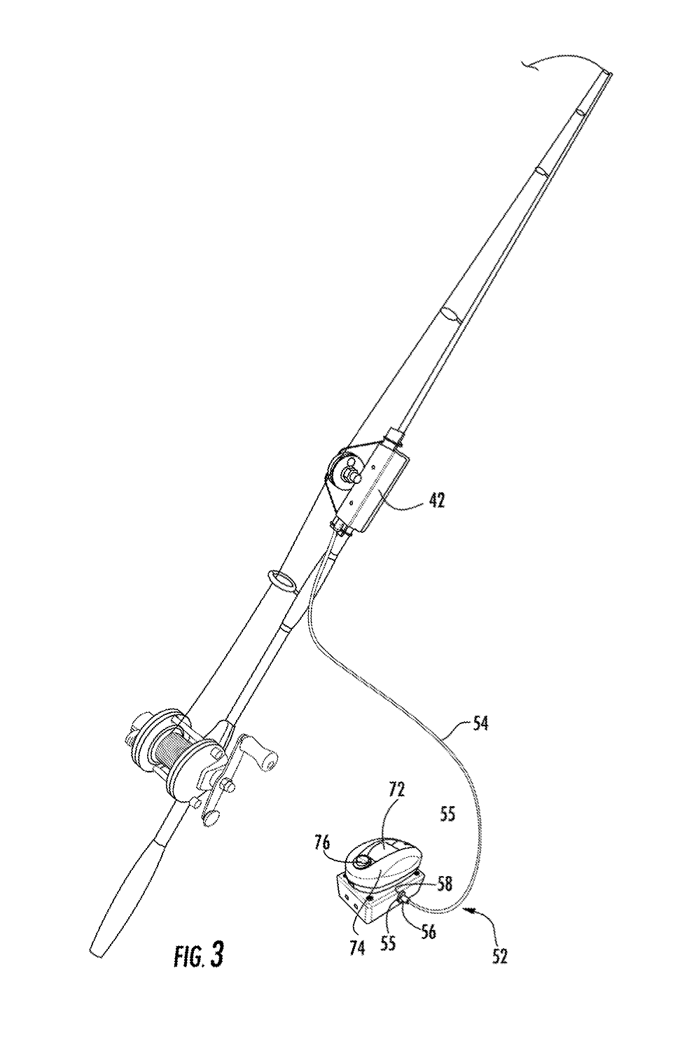

Referring to FIG. 3, a transmitting unit 52, which is capable of transmitting information to a receiver unit, is shown. The sensing member 42 is in electrical communication with the transmitting unit 52 via an intermediate wire 54 for providing the transmitting unit with sensory information (i.e., information that the sensing member 42 is switching between open and closed). The intermediate wire 54 includes an output plug 56 that plugs into an input connector 58 on the transmitting unit 52 for facilitating sensory information to the transmitting unit 52. In an embodiment, the intermediate wire 54 may be unplugged from the sensing member 42. The body 53 of the transmitting unit 52 includes an on/off switch 55 that controls power to the transmitting unit 52.

In one non-limiting embodiment, the transmitting unit 52 includes between one and eight input connectors 58 for receiving and facilitating transmission information of one to eight sensing units 12. In this embodiment, up to eight separate sensing units connect via a wired plug to the transmitting unit 52 for receiving information relating to eight separate fishing lines on separate fishing poles 18.

Referring now to FIG. 4, is a retaining member 57 for retaining wheel 30 about the bracket.

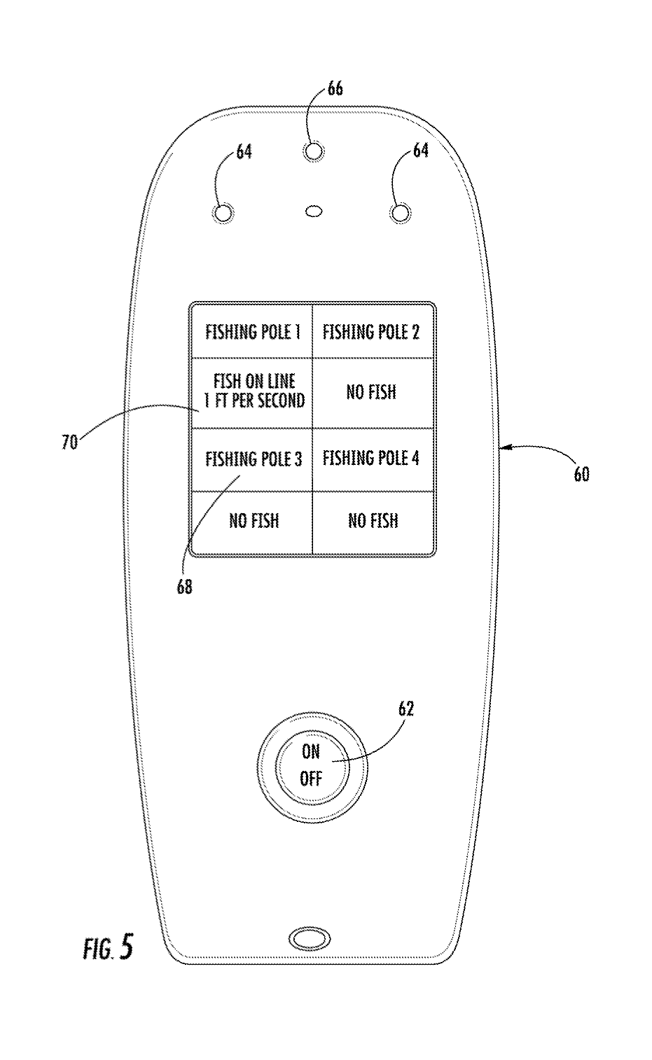

Referring now to FIG. 5, a receiving unit 60, which is capable of receiving sensory information from the transmitting unit 52 via signal transmission(s), is shown. The receiving unit is capable of wirelessly receiving sensory information from signal transmissions form one or more transmitting units 52 for monitoring one or more fishing poles 18, simultaneously. Any and all means of wireless signal transmission between the transmitting unit 52 and the receiving unit 60 is contemplated and within the spirit and scope of the present invention.

In an embodiment, the transmitting unit 52 is capable of sending signal transmissions indicating opening and closing of the sensing member 42 to multiple receiving units 60 simultaneously.

In one embodiment, the receiving unit 60 receives signal bursts transmitted from the transmitting unit 52 over a frequency range (e.g. 403 MHz, with a 1500 m open air range).

The receiving unit 60 and the transmitting unit 52 are in wireless communication. The wireless communication can be any known and understood wireless communication, including without limitation radio communications, Bluetooth communication, and infrared communication. The receiving unit 60 includes an on/off switch 62 for powering the receiving unit 60 between an on and off state. The receiving unit 60 includes multiple indicator lights 64, the indicator lights 64 are configured to alert via LED lights that the sensing device 12 has detected the presence of a fish on the line 50. For example, the indicator lights 64 may illuminate following the first pass of the magnet 46 about the sensing member 42. In one non-limiting embodiment, the indicator light 64 is illuminated until reset by a user. The illumination of the indicator lights 64, upon detection of fishing line 50 being let out from the fishing pole 18, may include solid illumination or a pattern of illumination. The pattern of illumination could include flashing.

The receiving unit 60 may optionally further include action light 66 that is energized to illumination for each pass of the magnet 46 about the sensing member 42.

In one embodiment, the receiving unit 60 includes a display 68, the display 68 provides information relating to one or more fishing poles. In particular, each of the one or more fishing poles may include a transmitting unit 52 and a sensing device 12 for alerting to the receiving unit 60 the status of the fishing line on the one or more fishing poles. The display 68 may be able to display fishing line 50 status for an unlimited number of fishing poles 18. In one embodiment, the display 68 receives and outputs sensory information that translates to the line speed 70 of the line being let out of any given the fishing pole being monitored by the receiving unit 60. For example, in one non-limiting embodiment, the fishing system 10 calculates the speed of the line existing the fishing pole 18 based on the time between two or more consecutive switches between open/closed.

The transmitting unit 52 further includes a transceiver for transmitting to the receiving unit 60. Any transceiver and receiver capable of sending and receiving sensing information, respectively, is within the spirit and scope of the instant invention.

In one non-limiting embodiment, the transmitting unit 52 and the receiving unit 60 are in radio communication. In operation, the transmitting unit 52 transmits to one or more receiving units 60 for alerting one or more of the ship captain, crew, and/or passengers/guests of a fish on the line of one or more fishing poles 18, which the fishing system 10 alerts when line is let out from one of the monitored fishing poles 18.

In one operation, the fishing line 50 imparts rotation of the wheel 30 as fishing line 50 is let out from the fishing pole 18. The rotation of the wheel 30 causes the magnet to pass a portion of the sensing member 42, which in turn causes the sensing member 42 to open and close. In one non-limiting embodiment, the fishing system 10 is capable of calculating line speed exiting the fishing pole 18 from sensory data/information obtained from multiple complete rotations of the wheel 30 about its axis (e.g. determining and/or displaying on the display 68 the amount of line taken out from the fishing pole; determining and/or displaying the present speed of the line exiting and/or reentering the fishing pole; determining and/or displaying the amount of remaining line taken out from the fishing pole and reducing that number as the line is reeled back around the fishing reel).

In one non-limiting embodiment, the transmitting unit 52 includes an integrated motion detector 72. The body 74 of the motion detector 72 includes an on/off switch 76 for controlling power on/off power to the integrated motion detector 72. The motion detector 72 triggers from detection from an infrared energy source emitted from humans. When the motion detector 72 triggers, the transmitting unit 52 transmits a trigger to the receiving unit for alerting of the detected motion, the alert may include without limitation sound and light(s).

In one non-limiting alternate embodiment, the transmitting unit is in wireless communication with one to eight separate sensing units 12, allowing for a single transmitting unit 52 for monitoring more than one sensing units 12.

While the instant invention depicts a baitcaster fishing rod and reel, one alternate embodiment can be implemented with other types of reels, including spinning reels, spin-caster reels, and spinning reels.

As used herein, when the term “and/or” is used, it shall include all combinations of one or more of the associated described items.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are contemplated in light of the above teachings without departing from the scope and spirit of the invention. It will be readily apparent that various changes may be made thereto without departing from the spirit and scope of the disclosure or sacrificing all of its material advantages. The examples and embodiments described herein are merely exemplary of the instant disclosure.

What is claimed is:

1. A fishing line detection system comprising:
a sensing device securable against a length of a fishing pole between two fishing pole eyelets, the fishing pole having a fishing line, said sensing device includes a sensing member;
a transmitting unit in electrical communication with said sensing member, said sensing member capable of providing fishing line data relating to a release of the fishing line from the fishing pole, said transmitting unit capable of wireless transmission of fishing line data; and
a receiving unit having at least one digital indicator, said receiving unit capable of receiving said transmission of fishing line data from said transmitting unit, said receiving unit capable of displaying a notification alerting of the release of the fishing line from the fishing pole.

2. The fishing line detection system of claim 1 further including an l-shaped bracket for coupling said sensing device to the length of the fishing pole.

3. The fishing system of claim 2 wherein said l-shaped bracket has an upper end and a lower end, said upper end and said lower end securable to the fishing pole via securement members.

4. The fishing system of claim 3 wherein said transmitting unit sends signal transmission indicating opening and closing of said sensing member.

5. The fishing system of claim 4 wherein said transmitting unit transmits fishing line data to a plurality of receiving units simultaneously.

6. The fishing system of claim 5 wherein said plurality of receiving units receive signal bursts from said transmitting unit.

7. The fishing system of claim 1 wherein said receiving unit displays a speed of the fishing line being taken out.

8. The fishing system of claim 1 wherein said receiving unit displaying an amount of line taken out in a number format.

9. The fishing system of claim 1 further comprising a motion detector integrated into said transmitting unit.

10. The fishing system of claim 9 wherein said receiving unit alerts of a detected motion within a proximity of said motion detector.

11. The fishing system of claim 1, wherein said transmitting unit is capable of transmitting to at least one receiving unit.

12. A fishing line detection system comprising:
a sensing device securable against a length of a fishing pole between two fishing pole eyelets of the fishing pole, said sensing device includes an l-shaped bracket;
a rotatable wheel having a rotatable outer surface, said rotatable wheel affixed to said l-shaped bracket, said rotatable wheel includes a magnetic member affixed about said rotatable outer surface; and
a sensing member secured against said l-shaped bracket, said sensing member switches between an open/closed state from each pass of said magnetic member across said sensing member.

13. The fishing line detection system of claim 12, further including a transmitting unit and a receiving unit in electrical communication with said sensing device.

14. The fishing line detection system of claim 13, wherein said transmitting unit includes an outer body that contains electrical components of said transmitting unit, said outer body includes a power on/off switch.

15. The fishing line detection system of claim 14, wherein said outer body includes an integrated motion detector for sending infrared motion detection data to said receiving unit.

16. The fishing line detection system of claim 12, wherein the rotatable wheel is rotated via a fishing line let out from the fishing pole.
